(19) United States
(12) Patent Application Publication
(10) Pub. No.: US 2021/0012275 A1
(43) Pub. Date: Jan. 14, 2021

(54) PACKAGE SHIPPING SYSTEM BY USING CHARACTERISTIC IDENTIFIER DATA AND METHOD THEREOF

(71) Applicant: Hye Sun SONG, Seoul (KR)

(72) Inventor: Hye Sun SONG, Seoul (KR)

(21) Appl. No.: 16/705,554

(22) Filed: Dec. 6, 2019

(30) Foreign Application Priority Data
Jul. 12, 2019 (KR) 10-2019-0084477

(51) Int. Cl. G06Q 10/08

(52) U.S. Cl. CPC G06Q 10/0832; G06Q 10/0833; G06Q 10/0835

(57) ABSTRACT

A package shipping system includes package that indicates characteristic identifier data provided by display area of smart user device, a smart user device that connects to management server, sends user and recipient information, receives the characteristic identifier, a management server that receives user and recipient information, generates characteristic identifier, matches and creates the DB using user information, recipient information and characteristic identifier data, sends characteristic identifier data to the smart user device, receives characteristic identifier data attached to the package from the smart device of the designated shipper, and sends recipient address information that matches characteristic identifier data to the smart device, a scanner that scans characteristic identifier information on the package classified according to the target delivery area and sends data to the smart device, and a smart device that receives and saves characteristic identifier data, sends characteristic identifier data to the management server, and receives recipient address information.

### CROSS-REFERENCE TO RELATED APPLICATION

This application claims priority to Korean Patent Application No. 10-2019-0084477, filed Jul. 12, 2019, the entire content of which is hereby incorporated by reference.

### BACKGROUND

### 1. Field of the Invention

This invention relates to a package shipping system by using characteristic identifier and the method thereof. This system allows shippers to deliver a package like postal mail or product purchased from an online shopping mall by only indicating a characteristic identifier that does not include personal information such as address, postal code and phone number of the sender and recipient on the outer cover of the package.

### 2. Description of Related Art

The conventional art related to this invention is disclosed in Korean Patent Application Publication No. 10-2018-0023316 (disclosed on Mar. 7, 2018). FIG. 1 is the block diagram of the conventional identifier-based package shipping system. In FIG. 1, the conventional identifier-based package shipping system may include service provider devices (100), service server (20) and customer device (10). The service provider devices (100) refer to devices that can scan an identifier and read information of the scanned identifier. In addition, the service provider devices (100) may include a computer processor (112), memory (113), display area (114), hardware and software (115), camera (116) and service application (not included in the figure) according to an embodiment. Here, the application is sometimes called the app, and the terms ‘application’ and ‘app’ are used to mean the same in this specification. In addition, the service application is embodied as a program command to be executed via various computer means to execute the identifier-based package shipping service and may be recorded onto a computer medium combined with hardware of the service provider device (100). In addition, the service provider devices (100) can be made into different devices that include a computer processor (112), for instance a PC (Personal Computer), smartphone, smart watch, tablet PC, PDA phone or laptop, memory (113), display area (114), hardware and software (115) and camera (166) for scanning of identifier. Here, the smartphone refers to a mobile phone that offers the same functions as a PC and additional advanced functions. The smart watch refers to an embedded watch that has improved functions compared to ordinary watch. The tablet PC is a portable PC that uses a touchscreen as the main input device. The PDA phone refers to a PDA (Personal Digital Assistant) mounted with a telecommunication module. Here, a software program that is run under control of the computer processor (112) is saved in the memory (113). The display area (114) may be embodied into a device like monitor, and hardware and software (115) collectively refer to additional components needed to operate the service provider devices (100). The service provider devices (100) include the registration team device (110) to register the package, the shi3pping team device (120) to deliver the package to the destination, and the receiving team device (130) of the team that receives the package. The registration team device (110) scans the identifier attached to the package, matches shipping information with scanned identifier information, and performs the registration step of saving information as registration information on the customer DB (30). The shipping team device (120) scans the identifier attached to the package after registration is completed by the registration team device (110) and sends scanned identifier information and current shipping status information to the service server (20). The receiving team device (130) scans the identifier attached to the package received from the shipping team and sends scanned identifier information and current shipping status information of the package to the service server (20). According to an embodiment, the service provider devices (100) may include a reader to recognize the identifier. The reader can be embodied into a device separated from the service provider devices (100) or an embedded device included in the service provider devices (100). For instance, the reader embedded in the registration team device (110) scans the identifier attached to the package and recognizes scanned identifier information. The reader embedded in the shipping team device (120) scans the identifier attached to the package received from the registration team and recognizes scanned identifier information. The reader embedded in the receiving team device (130) scans the identifier attached to the package received from the shipping team and recognizes scanned identifier information. The service server (20) saves and manages the service application according to an embodiment of this invention and can send the customer service application to a customer device (10) when a download request is received from the customer device (10). The service server (20) may include a program that executes the identifier-based package shipping service according to this invention (hereinafter referred to as the ‘service program’). In addition, the service program is embodied into a program command to be executed via various computer means to execute the identifier-based package shipping service and may be recorded onto a computer medium combined with hardware of the service server (20). According to an embodiment, the service server (20) updates registration information matched with identifier information received from the service provider devices (100) as shipping status information of the package received from the shipping team device (120). For instance, when the service server (20) receives identifier information and current shipping status information from the shipping team device (120), it finds registration information of the package that matches identifier information received and updates shipping status information of the package by referring to current shipping status information received. For another instance, when the service server (20) receives identifier information and current shipping status information of the package from the receiving team device (130), it finds registration information of the package that matches identifier information received and updates shipping status information of the package by referring to current shipping status information received. In other words, the service server (20) updates shipping status information of the package whenever it receives current shipping status information of the package from the shipping team device (120) or receiving team device (130).

### SUMMARY OF THE INVENTION

The conventional art consisting of the above saves all of shipping information onto the tag attached to the package, requiring a tag with large memory. Illegal scanning of the tag can result in illegal hacking of personal information such as address, phone number and name. In addition, the conventional art scans the tag and sends tag information to the server. Since the registration team device, shipping team device and receiving team device scan tag information and send it to the server every time to inform current status of the package, the conventional art causes unnecessary traffic and inefficiency issue. Therefore, the purpose of this invention is to only indicate the characteristic identifier on the package shipped so as to prevent leakage of personal information of the sender and recipient to third persons. In addition, another purpose of this invention is to only indicate simple characteristic identifier information on the outside of the package to reduce inconvenience of the user from writing address, name and phone number.

The package shipping system of this invention using characteristic identifier data with the purposes is characterized by a package that indicates characteristic identifier data provided by the display area of a smart user device on the outer cover using letters, a smart user device (220) that connects to the management server of the post office, sends user and recipient information to be turned into a DB, receives and saves the characteristic identifier generated by the management server of the post office, and provides the characteristic identifier via the display area, a management server of the post office that receives user and recipient information from the smart user device, generates a characteristic identifier, matches and creates the DB using user information, recipient information and characteristic identifier data, sends characteristic identifier data to the smart user device, receives characteristic identifier data attached to the package from the smart device of the designated shipper, and sends recipient's address information that matches characteristic identifier data to the smart device of the shipper, a scanner that scans characteristic identifier information indicated on the outer cover of the package classified according to the target delivery area and sends data to the smart device of the shipper, and a smart device of the shipper that receives and saves characteristic identifier data from the scanner, sends characteristic identifier data saved to the management server of the post office, and receives recipient's address information from the management server of the post office.

### Advantageous Effects

The package shipping system of this invention using characteristic identifier data comprised of the above and the method thereof have an effect of protecting user information and recipient information by concealing package shipping information such as address, phone number and name from third persons by only indicating characteristic identifier data on the package. In addition, since this invention ships packages based upon characteristic identifier data issued by the management server of the post office, the system offers convenient shipping and has great adaptability by issuing multiple identifiers when shipping packages to many recipients. This invention also has an effect of efficiently shipping packages without errors by shipping based on the system.

### BRIEF DESCRIPTION OF THE DRAWINGS

FIG. 1 is the block diagram of the conventional identifier-based package shipping service system.

FIG. 2 is the block diagram of the 1st embodiment for the package shipping system of this invention using characteristic identifier data.

FIG. 3 is the block diagram of the 2nd embodiment for the package shipping system of this invention using characteristic identifier data.

FIG. 4 is the block diagram of the 3rd embodiment for the package shipping system of this invention using characteristic identifier data.

FIG. 5 is the block diagram of the 4th embodiment for the package shipping system of this invention using characteristic identifier data.

FIG. 6 is the control flow diagram of the 1st embodiment for the package shipping system of this invention using characteristic identifier data.

FIG. 7 is the control flow diagram of the 2nd embodiment for the package shipping system of this invention using characteristic identifier data FIG. 8 is the control flow diagram of the 3rd embodiment for the package shipping system of this invention using characteristic identifier data.

FIG. 9 is the control flow diagram of the 4th embodiment for the package shipping system of this invention using characteristic identifier data.

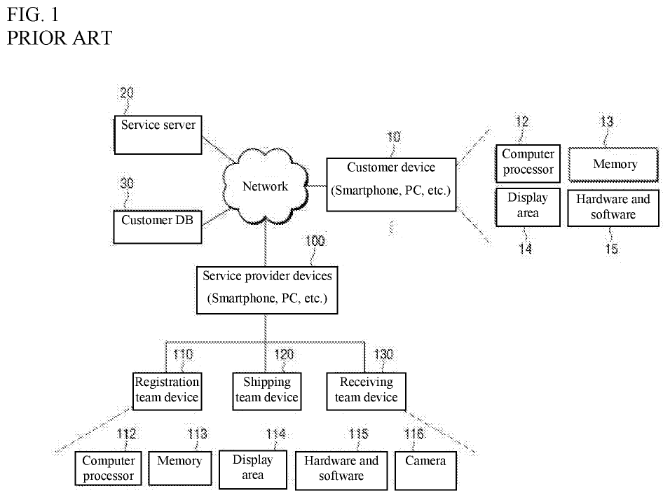

### DETAILED DESCRIPTION OF THE INVENTION

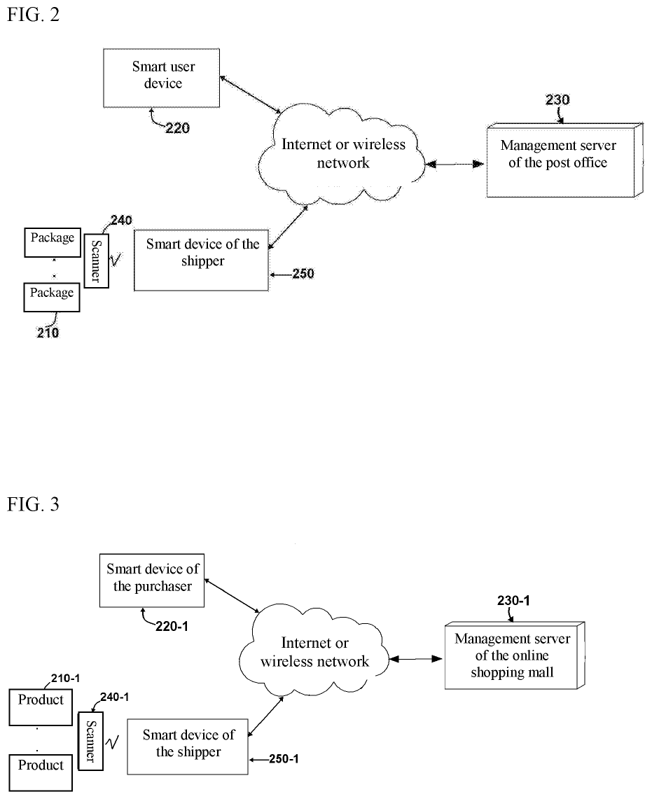

The package shipping system of this invention based on characteristic identifier data with the purposes and the method thereof can be explained as below upon FIGS. 2 through 9.

FIG. 2 is the block diagram of the 1st embodiment for the package shipping system of this invention using characteristic identifier data. In FIG. 2, the 1st embodiment for the package shipping system of this invention using characteristic identifier data is characterized by a package (210) that indicates characteristic identifier data on the display area of the smart user device in letters, a smart user device (220) that connects to the management server of the post office, sends user information and recipient information to create the DB, receives characteristic identifier data generated by the management server of the post office, and provides data through the display area, a management server of the post office (230) that receives user information and recipient information from the smart user device, generates a characteristic identifier, stores characteristic identifier data on the DB, sends characteristic identifier data to the smart user device, receives characteristic identifier data attached to the package from the smart device of the designated shipper, and sends recipient's address information that matches characteristic identifier data to the smart device of the shipper, a text scanner (240) that scans characteristic identifier data indicated on the package classified according to the target delivery area and sends data to the smart device of the shipper, and a smart device of the shipper (250) that receives and saves characteristic identifier data from the text scanner, sends characteristic identifier data saved to the management server of the post office, and receives package recipient's address information from the management server of the post office. In the above, characteristic identifier data can be number information, photo information or combination of letters and numbers like a password. In the above, the scanner and smart user device support local area communication. The text scanner is a text scanner that can read letters of the Korean and English languages, Arabic numbers and special characters written in ways on the outer cover of the package.

FIG. 3 is the block diagram of the 2nd embodiment for the package shipping system of this invention using characteristic identifier data. In FIG. 3, the 2nd embodiment for the package shipping system of this invention using characteristic identifier data is about purchasing and shipping a product from an online shopping mall and is characterized by a product (210-1) that is indicated with characteristic identifier data provided by the management server of the online shopping mall on the outer cover in letters, a smart device of the purchaser (220-1) that connects to the management server of the online shopping mall, provides purchaser information such as name, address and phone number of the purchaser, and purchases the product, a management server of the online shopping mall (230-1) that creates the DB using purchaser information provided by the smart device of the purchaser, purchased product information and characteristic identifier data of the purchased product, provides characteristic identifier data to the worker, receives characteristic identifier data from the smart device of the shipper, and sends purchased product information and product recipient information that match characteristic identifier data received, a text scanner (240-1) that scans characteristic identifier data indicated by the online shopping mall and sends characteristic identifier data to the smart device of the shipper, and a smart device of the shipper (250-1) that receives and saves characteristic identifier data from the text scanner, sends characteristic identifier data to the management server of the online shopping mall, receives and saves purchased product information and recipient information from the management server of the online shopping mall, and provides information through the display area for delivery. In the above, the smart device of the shipper (250-1) receives position information from the GPS satellite and provides recipient's address information and characteristic identifier data that match position information through the display area when the package arrives at position information that matches recipient's address received from the management server of the online shopping mall so that the shipper can deliver the package. In addition, the smart device of the shipper receives path information for recipient's address in connection with navigations like T Map. In the above, if the recipient is the same as the purchaser, purchaser information becomes recipient information. If the recipient is not the same as the purchaser, the smart device of the purchaser can provide recipient information such as address, name and phone number of the recipient upon purchase.

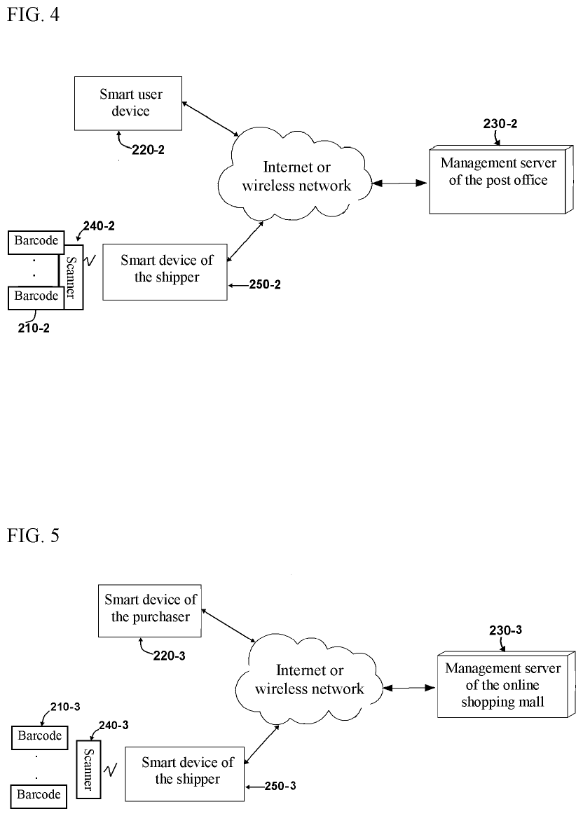

FIG. 4 is the block diagram of the 3rd embodiment for the package shipping system of this invention using characteristic identifier data. In FIG. 4, the 3rd embodiment for the package shipping system of this invention using characteristic identifier data is characterized by a barcode (210-2) that prints characteristic identifier data provided on the display area of the smart user device using a printer and attaches it to the package, a smart user device (220-2) that connects to the management server of the post office, creates the DB by sending user information and recipient information, receives and saves characteristic identifier data generated by the management server of the post office, and provides data through the display area, a management server of the post office (230-2) that receives user information and recipient information from the smart user device, generates a characteristic identifier, creates the DB by matching user information, recipient information and characteristic identifier data, sends characteristic identifier data to the smart user device, receives characteristic identifier data from the smart device of the designated shipper, and sends recipient's address information that matches characteristic identifier data to the smart device of the shipper, a barcode scanner (240-2) that extracts characteristic identifier data from barcode information attached to the package and sends characteristic identifier data extracted to the smart device of the shipper, and a smart device of the shipper (250-2) that receives and saves characteristic identifier data from the barcode scanner, sends characteristic identifier data saved to the management server of the post office, and receives package recipient's address information from the management server of the post office.

FIG. 5 is the block diagram of the 4th embodiment for the package shipping system of this invention using characteristic identifier data. In FIG. 5, the 4th embodiment for the package shipping system of this invention using characteristic identifier data is about purchasing and shipping a product from an online shopping mall and is characterized by a barcode (210-3) that prints characteristic identifier data provided by the management server of the online shopping mall using a printer and attaches it to the product, a smart device of the purchaser (220-3) that connects to the management server of the online shopping mall, provides purchaser information such as name, address and phone number, and purchases the product, a management server of the online shopping mall (230-3) that creates the DB using purchaser information provided by the smart device of the purchaser, purchased product information and characteristic identifier data generated for the purchased product, receives characteristic identifier data from the smart device of the shipper, and sends product recipient information that matches characteristic identifier data to the smart device of the shipper, a barcode scanner (240-3) that scans the barcode attached to the product, extracts characteristic identifier data, and sends characteristic identifier data extracted to the smart device of the shipper, and a smart device of the shipper (250-3) that receives characteristic identifier data from the barcode scanner, sends characteristic identifier data received to the management server of the online shopping mall, receives and saves recipient information that corresponds to characteristic identifier data from the management server of the online shopping mall, and provides recipient information through the display area. In the above, the smart device of the shipper (250-3) receives real-time position information from GPS and provides recipient's address information that agrees with position information through the display area when the package arrives at position information that matches recipient's address received from the management server of the online shopping mall so that the shipper can deliver the package. In addition, the smart device of the shipper (250-3) receives path information for recipient's address in connection with navigations like T Map. In the above, if the recipient is the same as the purchaser, purchaser information becomes recipient information. If the recipient is not the same as the purchaser, the smart device of the purchaser can provide recipient information such as address, name and phone number of the recipient upon purchase.

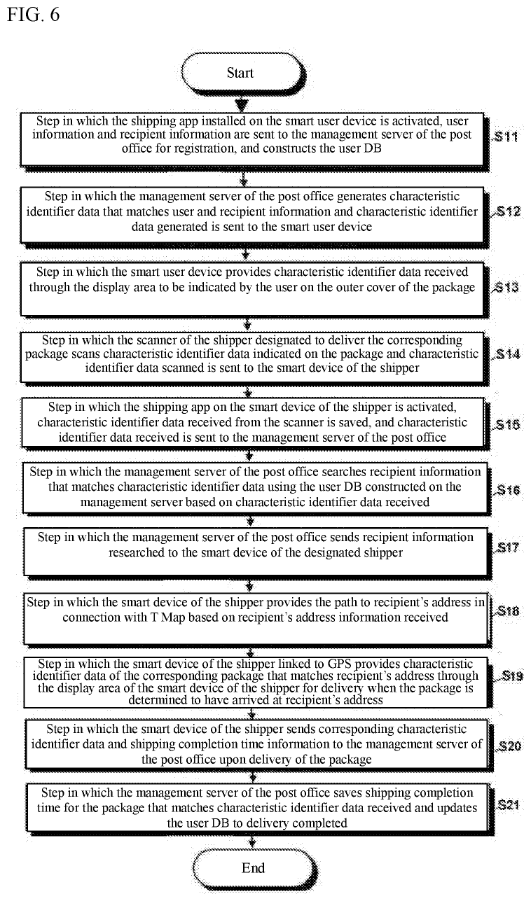

FIG. 6 is the control flow diagram of the 1st embodiment for the package shipping system of this invention using characteristic identifier data. In FIG. 6, the 1st embodiment for the package shipping method of this invention using characteristic identifier data is characterized by a step (S11) in which the shipping app installed on the smart user device is activated, user information such as phone number, address and name of the user and recipient information such as phone number, address and name of the package recipient are sent to the management server of the post office for registration, and constructs the user DB, a step (S12) in which the management server of the post office generates characteristic identifier data that matches user and recipient information and characteristic identifier data generated is sent to the smart user device, a step (S13) in which the smart user device provides characteristic identifier data received through the display area to be indicated by the user on the outer cover of the package, a step (S14) in which the scanner of the shipper designated to deliver the corresponding package scans characteristic identifier data indicated on the package and characteristic identifier data scanned is sent to the smart device of the shipper, a step (S15) in which the shipping app on the smart device of the shipper is activated, characteristic identifier data received from the scanner is saved, and characteristic identifier data received is sent to the management server of the post office, a step (S16) in which the management server of the post office searches recipient information that matches characteristic identifier data using the user DB constructed on the management server based on characteristic identifier data received, a step (S17) in which the management server of the post office sends recipient information searched to the smart device of the designated shipper, a step (S18) in which the smart device of the shipper provides the path to recipient's address in connection with T Map based on recipient's address information received, a step (S19) in which the smart device of the shipper linked to GPS provides characteristic identifier data of the corresponding package that matches recipient's address through the display area of the smart device of the shipper for delivery when the package is determined to have arrived at recipient's address, a step (S20) in which the smart device of the shipper sends corresponding characteristic identifier data and shipping completion time information to the management server of the post office upon delivery of the package, a step (S21) in which the management server of the post office saves shipping completion time for the package that matches characteristic identifier data received and updates the user DB to delivery completed. In addition, the step (S18) in which the smart device of the shipper provides the path to recipient's address in connection with T Map can sequentially provide recipient information via T Map based on the current position of the smart device of the shipper if the smart device of the shipper receives multiple recipient addresses to deliver multiple packages. In addition, the step (S19) in which the smart device of the shipper linked to GPS provides characteristic identifier data of the corresponding package that matches recipient's address through the display area of the smart device of the shipper for delivery when the package is determined to have arrived at recipient's address may have the smart device of the shipper receive real-time position information from GPS and provide characteristic identifier data that matches recipient's address via the display area if position information agrees with recipient's address so that the corresponding package can be delivered. In addition, characteristic identifier data may be an alias number. Generally, one characteristic identifier is granted to one package. A characteristic identifier may be issued by matching one user who wishes to send a package and one recipient who wishes to receive the package. If there is one user who wishes to send packages and multiple recipients, the number of characteristic identifiers issued can be identical to the number of recipients. In addition, the step (S16) in which the management server of the post office searches recipient information that matches characteristic identifier data using the user DB constructed on the management server based on characteristic identifier data received can have the management server search recipient's address and phone number information at the same time and provide user information or package shipping position information of the corresponding package based on phone number information searched. In the above, package shipping position information can provide current position information or delivery completion information of the package and delivery completion time information by combining characteristic identifier information of the package, position information sent by the smart device of the shipper, delivery completion information, and delivery completion time information. In addition, if multiple packages are shipped to multiple recipients or the same package is shipped to multiple recipients, S11 can have the smart user device sent multiple recipient information to the management server of the post office so that as many characteristic identifiers as the number of multiple recipients are created and sent to the smart user device in S12.

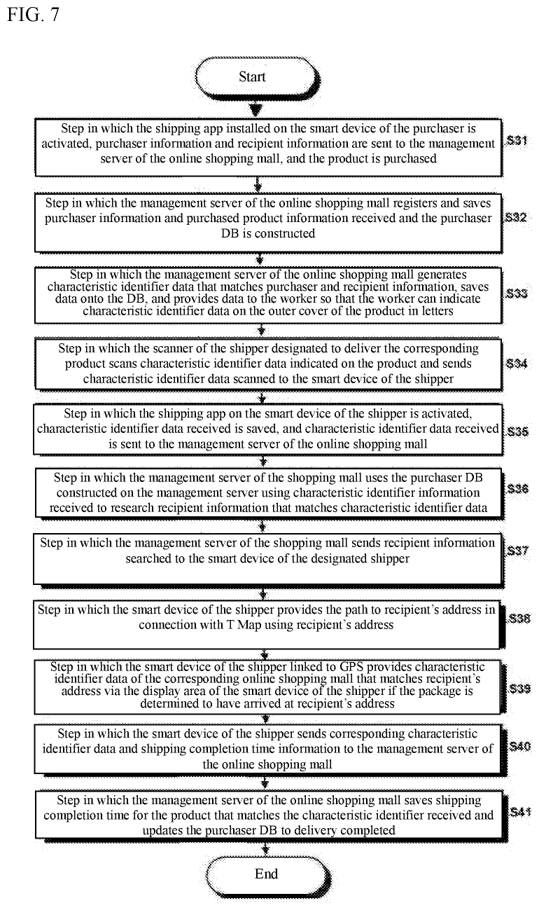

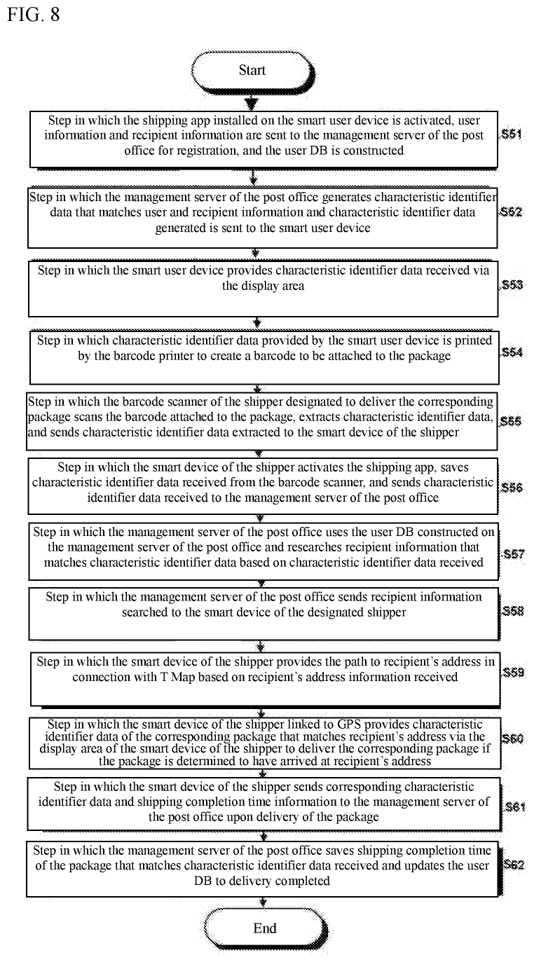

FIG. 7 is the control flow chart of the 2nd embodiment for the package shipping method of this invention using characteristic identifier data. In FIG. 7, the 2nd embodiment for the package shipping method of this invention using characteristic identifier data is about shipping of a product purchased by a purchaser from an online shopping mall and is characterized by a step (S31) in which the shipping app installed on the smart device of the purchaser is activated, purchaser information such as phone number, address and name of the purchaser and recipient information such as phone number, address and name of the recipient are sent to the management server of the online shopping mall, and the product is purchased, a step (S32) in which the management server of the online shopping mall registers and saves purchaser information and purchased product information received and the purchaser DB is constructed, a step (S33) in which the management server of the online shopping mall generates characteristic identifier data that matches purchaser and recipient information, saves data onto the DB, and provides data to the worker so that the worker can indicate characteristic identifier data on the outer cover of the product in letters, a step (S45) in which the scanner of the shipper designated to deliver the corresponding product scans characteristic identifier data indicated on the product and sends characteristic identifier data scanned to the smart device of the shipper, a step (S35) in which the shipping app on the smart device of the shipper is activated, characteristic identifier data received is saved, and characteristic identifier data received is sent to the management server of the online shopping mall, a step (S36) in which the management server of the shopping mall uses the purchaser DB constructed on the management server using characteristic identifier information received to research recipient information that matches characteristic identifier data, a step (S37) in which the management server of the shopping mall sends recipient information searched to the smart device of the designated shipper, a step (S38) in which the smart device of the shipper provides the path to recipient's address in connection with T Map using recipient's address, a step (S39) in which the smart device of the shipper linked to GPS provides characteristic identifier data of the corresponding online shopping mall that matches recipient's address via the display area of the smart device of the shipper if the package is determined to have arrived at recipient's address, a step (S40) in which the smart device of the shipper sends corresponding characteristic identifier data and shipping completion time information to the management server of the online shopping mall, and a step (S41) in which the management server of the online shopping mall saves shipping completion time for the product that matches the characteristic identifier received and updates the purchaser DB to delivery completed. In addition, the step (S38) in which the smart device of the shipper provides the path to recipient's address in connection with T Map can sequentially provide recipient information via T Map based on the current position of the smart device of the shipper if the smart device of the shipper receives multiple recipient addresses to deliver multiple packages. In addition, the step (S39) in which the smart device of the shipper linked to GPS provides characteristic identifier data of the corresponding online shopping mall that matches recipient's address via the display area of the smart device of the shipper if the package is determined to have arrived at recipient's address may have the smart device of the shipper receive real-time position information from GPS and provide characteristic identifier data that matches recipient's address for delivery if position information agrees with recipient's address. In addition, characteristic identifier data may be an alias number. Generally, one characteristic identifier is granted to one package. A characteristic identifier may be issued by matching one user who wishes to send a package and one recipient who wishes to receive the package. If there is one user who wishes to send packages and multiple recipients, the number of characteristic identifiers issued can be identical to the number of recipients. In addition, the step (S36) in which the management server of the online shopping mall uses the purchase DB constructed on the management server and searches recipient information that matches characteristic identifier data received can have the management server search recipient's address and phone number information at the same time and provide purchaser information or current position information of the product based on phone number information searched. In the above, current position information of the product can provide current position information or delivery completion information of the product and delivery completion time information by combining characteristic identifier data of the product, position information sent by the smart device of the shipper, delivery completion information, and delivery completion time information. In addition, if multiple products are shipped to multiple recipients or the same product is shipped to multiple recipients, S31 can have the smart device of the purchaser send multiple recipient information to the management server of the online shopping mall so that as many characteristic identifiers as the number of multiple recipients are created and indicated on each product in S33. In addition, if the recipient is the same as the purchaser, purchaser information can become recipient information.

FIG. 8 is the control flow diagram of the 3rd embodiment for the package shipping method of this invention using characteristic identifier data. In FIG. 8, the 3rd embodiment for the package shipping method of this invention using characteristic identifier data is characterized by a step (S51) in which the shipping app installed on the smart user device is activated, user information such as phone number, address and name of the user and recipient information such as phone number, address and name of the package recipient are sent to the management server of the post office for registration, and the user DB is constructed, a step (S52) in which the management server of the post office generates characteristic identifier data that matches user and recipient information and characteristic identifier data generated is sent to the smart user device, a step (S53) in which the smart user device provides characteristic identifier data received via the display area, a step (S54) in which characteristic identifier data provided by the smart user device is printed by the barcode printer to create a barcode to be attached to the package, a step (S55) in which the barcode scanner of the shipper designated to deliver the corresponding package scans the barcode attached to the package, extracts characteristic identifier data, and sends characteristic identifier data extracted to the smart device of the shipper, a step (S56) in which the smart device of the shipper activates the shipping app, saves characteristic identifier data received from the barcode scanner, and sends characteristic identifier data received to the management server of the post office, a step (S57) in which the management server of the post office uses the user DB constructed on the management server of the post office and researches recipient information that matches characteristic identifier data based on characteristic identifier data received, a step (S58) in which the management server of the post office sends recipient information searched to the smart device of the designated shipper, a step (S59) in which the smart device of the shipper provides the path to recipient's address in connection with T Map based on recipient's address information received, a step (S60) in which the smart device of the shipper linked to GPS provides characteristic identifier data of the corresponding package that matches recipient's address via the display area of the smart device of the shipper to deliver the corresponding package if the package is determined to have arrived at recipient's address, a step (S61) in which the smart device of the shipper sends corresponding characteristic identifier data and shipping completion time information to the management server of the post office upon delivery of the package, and a step (S62) in which the management server of the post office saves shipping completion time of the package that matches characteristic identifier data received and updates the user DB to delivery completed. In the above, characteristic identifier data generated by the management server of the post office creates the user DB by matching the user and recipient.

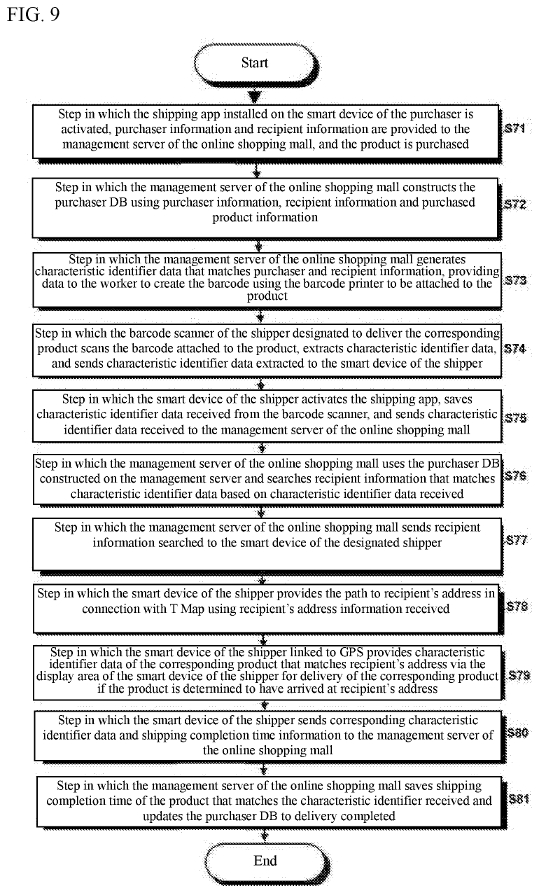

FIG. 9 is the control flow diagram of the 4th embodiment for the package shipping method of this invention using characteristic identifier data. In FIG. 9, the 4th embodiment for the package shipping method of this invention using characteristic identifier data is about shipping of a product purchased by a purchaser from an online shopping mall and is characterized by a step (S71) in which the shipping app installed on the smart device of the purchaser is activated, purchaser information such as phone number, address and name of the purchaser and recipient information such as phone number, address and name of the product recipient are provided to the management server of the online shopping mall, and the product is purchased, a step (S72) in which the management server of the online shopping mall constructs the purchaser DB using purchaser information, recipient information and purchased product information, a step (S73) in which the management server of the online shopping mall generates characteristic identifier data that matches purchaser and recipient information, providing data to the worker to create the barcode using the barcode printer to be attached to the product, a step (S74) in which the barcode scanner of the shipper designated to deliver the corresponding product scans the barcode attached to the product, extracts characteristic identifier data, and sends characteristic identifier data extracted to the smart device of the shipper, a step (S75) in which the smart device of the shipper activates the shipping app, saves characteristic identifier data received from the barcode scanner, and sends characteristic identifier data received to the management server of the online shopping mall, a step (S76) in which the management server of the online shopping mall uses the purchaser DB constructed on the management server and searches recipient information that matches characteristic identifier data based on characteristic identifier data received, a step (S77) in which the management server of the online shopping mall sends recipient information searched to the smart device of the designated shipper, a step (S78) in which the smart device of the shipper provides the path to recipient's address in connection with T Map using recipient's address information received, a step (S79) in which the smart device of the shipper linked to GPS provides characteristic identifier data of the corresponding product that matches recipient's address via the display area of the smart device of the shipper for delivery of the corresponding product if the product is determined to have arrived at recipient's address, a step (S80) in which the smart device of the shipper sends corresponding characteristic identifier data and shipping completion time information to the management server of the online shopping mall, and a step (S81) in which the management server of the online shopping mall saves shipping completion time of the product that matches the characteristic identifier received and updates the purchaser DB to delivery completed. In addition, the step (S78) in which the smart device of the shipper provides the path to recipient's address in connection with T Map can sequentially provide recipient information via T Map based on the current position of the smart device of the shipper if the smart device of the shipper receives multiple recipient addresses to deliver multiple packages. In addition, the step (S79) in which the smart device of the shipper linked to GPS provides characteristic identifier data of the corresponding online shopping mall that matches recipient's address via the display area of the smart device of the shipper if the package is determined to have arrived at recipient's address may have the smart device of the shipper receive real-time position information from GPS and provide characteristic identifier data that matches recipient's address for delivery if position information agrees with recipient's address. In addition, characteristic identifier data may be an alias number. Generally, one characteristic identifier is granted to one package. A characteristic identifier may be issued by matching one user who wishes to send a package and one recipient who wishes to receive the package. If there is one user who wishes to send packages and multiple recipients, the number of characteristic identifiers issued can be identical to the number of recipients. In addition, the step (S75) in which the management server of the online shopping mall uses the purchase DB constructed on the management server and searches recipient information that matches characteristic identifier data received can have the management server search recipient's address and phone number information at the same time and provide purchaser information or current position information of the product based on phone number information searched. In the above, current position information of the product can provide current position information or delivery completion information of the product and delivery completion time information by combining characteristic identifier data of the product, position information sent by the smart device of the shipper, delivery completion information, and delivery completion time information. In addition, if multiple products are shipped to multiple recipients or the same product is shipped to multiple recipients, S71 can have the smart device of the purchaser send multiple recipient information to the management server of the online shopping mall so that as many characteristic identifiers and barcodes as the number of multiple recipients are created in S73.

What is claimed is:

1. A package shipping system using characteristic identifier data intended to ship a package without exposing user information and recipient information, the package shipping system comprising:
a package (210) that indicates characteristic identifier data on the display area of the smart user device in letters;
a smart user device (220) that connects to the management server of the post office, sends user information and recipient information to create the DB, receives characteristic identifier data generated by the management server of the post office, and provides data through the display area;
a management server of the post office (230) that receives user information and recipient information from the smart user device, generates a characteristic identifier, stores characteristic identifier data on the DB, sends characteristic identifier data to the smart user device, receives characteristic identifier data attached to the package from the smart device of the designated shipper, and sends recipient's address information that matches characteristic identifier data to the smart device of the shipper;
a text scanner (240) that scans characteristic identifier data indicated on the package classified according to the target delivery area and sends data to the smart device of the shipper; and
a smart device of the shipper (250) that receives and saves characteristic identifier data from the text scanner, sends characteristic identifier data saved to the management server of the post office, and receives package recipient's address information from the management server of the post office.

2. A package shipping system using characteristic identifier data intended to ship a package without exposing user information and recipient information, the package shipping system comprising:
a product (210-1) that is indicated with characteristic identifier data provided by the management server of the online shopping mall on the outer cover in letters;
a smart device of the purchaser (220-1) that connects to the management server of the online shopping mall, provides purchaser information such as name, address and phone number of the purchaser, and purchases the product;
a management server of the online shopping mall (230-1) that creates the DB using purchaser information provided by the smart device of the purchaser, purchased product information and characteristic identifier data of the purchased product, provides characteristic identifier data to the worker, receives characteristic identifier data from the smart device of the shipper, and sends purchased product information and product recipient information that match characteristic identifier data received;
a text scanner (240-1) that scans characteristic identifier data indicated by the online shopping mall and sends characteristic identifier data to the smart device of the shipper; and
a smart device of the shipper (250-1) that receives and saves characteristic identifier data from the text scanner, sends characteristic identifier data to the management server of the online shopping mall, receives and saves purchased product information and recipient information from the management server of the online shopping mall, and provides information through the display area for delivery.

3. A package shipping system using characteristic identifier data intended to ship a package without exposing user information and recipient information, the package shipping system comprising:
a barcode (210-2) that prints characteristic identifier data provided on the display area of the smart user device using a printer and attaches it to the package;
a smart user device (220-2) that connects to the management server of the post office, creates the DB by sending user information and recipient information, receives and saves characteristic identifier data generated by the management server of the post office, and provides data through the display area;
a management server of the post office (230-2) that receives user information and recipient information from the smart user device, generates a characteristic identifier, creates the DB by matching user information, recipient information and characteristic identifier data, sends characteristic identifier data to the smart user device, receives characteristic identifier data from the smart device of the designated shipper, and sends recipient's address information that matches characteristic identifier data to the smart device of the shipper;
a barcode scanner (240-2) that extracts characteristic identifier data from barcode information attached to the package and sends characteristic identifier data extracted to the smart device of the shipper; and
a smart device of the shipper (250-2) that receives and saves characteristic identifier data from the barcode scanner, sends characteristic identifier data saved to the management server of the post office, and receives package recipient's address information from the management server of the post office.

4. A product shipping system using characteristic identifier data intended to ship a product without exposing user information and recipient information, the product shipping system comprising:
a barcode (210-3) that prints characteristic identifier data provided by the management server of the online shopping mall using a printer and attaches it to the product;
a smart device of the purchaser (220-3) that connects to the management server of the online shopping mall, provides purchaser information such as name, address and phone number, and purchases the product;
a management server of the online shopping mall (230-3) that creates the DB using purchaser information provided by the smart device of the purchaser, purchased product information and characteristic identifier data generated for the purchased product, receives characteristic identifier data from the smart device of the shipper, and sends product recipient information that matches characteristic identifier data to the smart device of the shipper;
a barcode scanner (240-3) that scans the barcode attached to the product, extracts characteristic identifier data, and sends characteristic identifier data extracted to the smart device of the shipper; and
a smart device of the shipper (250-3) that receives characteristic identifier data from the barcode scanner, sends characteristic identifier data received to the management server of the online shopping mall, receives and saves recipient information that corresponds to characteristic identifier data from the management server of the online shopping mall, and provides recipient information through the display area.

5. A package shipping method using characteristic identifier data intended to ship a package without exposing user information and recipient information, the package shipping method comprising:
a step (S11) in which the shipping app installed on the smart user device is activated, user information such as phone number, address and name of the user and recipient information such as phone number, address and name of the package recipient are sent to the management server of the post office for registration, and constructs the user DB;
a step (S12) in which the management server of the post office generates characteristic identifier data that matches user and recipient information and characteristic identifier data generated is sent to the smart user device;
a step (S13) in which the smart user device provides characteristic identifier data received through the display area to be indicated by the user on the outer cover of the package;
a step (S14) in which the scanner of the shipper designated to deliver the corresponding package scans characteristic identifier data indicated on the package and characteristic identifier data scanned is sent to the smart device of the shipper;
a step (S15) in which the shipping app on the smart device of the shipper is activated, characteristic identifier data received from the scanner is saved, and characteristic identifier data received is sent to the management server of the post office;
a step (S16) in which the management server of the post office searches recipient information that matches characteristic identifier data using the user DB constructed on the management server based on characteristic identifier data received; and
a step (S17) in which the management server of the post office sends recipient information searched to the smart device of the designated shipper.

6. The package shipping method of claim 5, further comprising a step (S18) in which the smart device of the shipper provides the path to recipient's address in connection with T Map based on recipient's address information received.

7. A product shipping method using characteristic identifier data to ship a product without exposing user information and recipient information, the product shipping method comprising:
a step (S31) in which the shipping app installed on the smart device of the purchaser is activated, purchaser information and recipient information are sent to the management server of the online shopping mall, and the product is purchased;
a step (S32) in which the management server of the online shopping mall registers and saves purchaser information and purchased product information received and the purchaser DB is constructed;
a step (S33) in which the management server of the online shopping mall generates characteristic identifier data that matches purchaser and recipient information, saves data onto the DB, and provides data to the worker so that the worker can indicate characteristic identifier data on the outer cover of the product in letters;
a step (S45) in which the scanner of the shipper designated to deliver the corresponding product scans characteristic identifier data indicated on the product and sends characteristic identifier data scanned to the smart device of the shipper;
a step (S35) in which the shipping app on the smart device of the shipper is activated, characteristic identifier data received is saved, and characteristic identifier data received is sent to the management server of the online shopping mall;
a step (S36) in which the management server of the shopping mall uses the purchaser DB constructed on the management server using characteristic identifier information received to research recipient information that matches characteristic identifier data; and
a step (S37) in which the management server of the shopping mall sends recipient information searched to the smart device of the designated shipper.

8. The product shipping method of claim 7, further comprising a step (S38) in which the smart device of the shipper provides the path to recipient's address in connection with T Map using recipient's address.

9. A package shipping method using characteristic identifier data to ship a package without exposing user information and recipient information, the package shipping method comprising:
a step (S51) in which the shipping app installed on the smart user device is activated, user information and recipient information are sent to the management server of the post office for registration, and the user DB is constructed;
a step (S52) in which the management server of the post office generates characteristic identifier data that matches user and recipient information and characteristic identifier data generated is sent to the smart user device;
a step (S53) in which the smart user device provides characteristic identifier data received via the display area;
a step (S54) in which characteristic identifier data provided by the smart user device is printed by the barcode printer to create a barcode to be attached to the package;
a step (S55) in which the barcode scanner of the shipper designated to deliver the corresponding package scans the barcode attached to the package, extracts characteristic identifier data, and sends characteristic identifier data extracted to the smart device of the shipper;
a step (S56) in which the smart device of the shipper activates the shipping app, saves characteristic identifier data received from the barcode scanner, and sends characteristic identifier data received to the management server of the post office;
a step (S57) in which the management server of the post office uses the user DB constructed on the management server of the post office and researches recipient information that matches characteristic identifier data based on characteristic identifier data received; and
a step (S58) in which the management server of the post office sends recipient information searched to the smart device of the designated shipper.

10. The package shipping method of claim 9, further comprising a step (S59) in which the smart device of the shipper provides the path to recipient's address in connection with T Map based on recipient's address information received.

11. The package shipping method of claim 9, further comprising a step (S60) in which the smart device of the shipper linked to GPS provides characteristic identifier data of the corresponding package that matches recipient's address via the display area of the smart device of the shipper to deliver the corresponding package if the package is determined to have arrived at recipient's address.

12. The package shipping method of claim 10, further comprising a step (S60) in which the smart device of the shipper linked to GPS provides characteristic identifier data of the corresponding package that matches recipient's address via the display area of the smart device of the shipper to deliver the corresponding package if the package is determined to have arrived at recipient's address.

13. A product shipping method using characteristic identifier data to ship a product without exposing user information and recipient information, the product shipping method comprising:
a step (S71) in which the shipping app installed on the smart device of the purchaser is activated, purchaser information and recipient information are provided to the management server of the online shopping mall, and the product is purchased;
a step (S72) in which the management server of the online shopping mall constructs the purchaser DB using purchaser information, recipient information and purchased product information;
a step (S73) in which the management server of the online shopping mall generates characteristic identifier data that matches purchaser and recipient information, providing data to the worker to create the barcode using the barcode printer to be attached to the product;
a step (S74) in which the barcode scanner of the shipper designated to deliver the corresponding product scans the barcode attached to the product, extracts characteristic identifier data, and sends characteristic identifier data extracted to the smart device of the shipper;
a step (S75) in which the smart device of the shipper activates the shipping app, saves characteristic identifier data received from the barcode scanner, and sends characteristic identifier data received to the management server of the online shopping mall;
a step (S76) in which the management server of the online shopping mall uses the purchaser DB constructed on the management server and searches recipient information that matches characteristic identifier data based on characteristic identifier data received; and
a step (S77) in which the management server of the online shopping mall sends recipient information searched to the smart device of the designated shipper.

14. The product shipping method of claim 13, further comprising a step (S78) in which the smart device of the shipper provides the path to recipient's address in connection with T Map using recipient's address information received.

15. The product shipping method of claim 13, further comprising a step (S79) in which the smart device of the shipper linked to GPS provides characteristic identifier data of the corresponding product that matches recipient's address via the display area of the smart device of the shipper for delivery of the corresponding product if the product is determined to have arrived at recipient's address.

16. The product shipping method of claim 14, further comprising a step (S79) in which the smart device of the shipper linked to GPS provides characteristic identifier data of the corresponding product that matches recipient's address via the display area of the smart device of the shipper for delivery of the corresponding product if the product is determined to have arrived at recipient's address.
